(19) United States
(12) Patent Application Publication
(10) Pub. No.: US 2024/0018065 A1
(43) Pub. Date: Jan. 18, 2024

(54) FERTILISER RING, METHOD AND PRODUCTION

(71) Applicants: Garry Kenneth Eglinton, Helena Valley (AU); Tyron Richard Clark, Bushmead (AU)

(72) Inventors: Garry Kenneth Eglinton, Helena Valley (AU); Tyron Richard Clark, Bushmead (AU)

(21) Appl. No.: 18/034,692

(22) PCT Filed: Nov. 2, 2021
(86) PCT No.: PCT/AU2021/051287

§ 371 Date: Apr. 29, 2023

(30) Foreign Application Priority Data
Nov. 3, 2020 (AU) 2020904000

(51) Int. Cl. C05G 5/10; C05B 15/00; C05G 3/60

(52) U.S. Cl. CPC C05G 5/10; C05B 15/00; C05G 3/60

(57) ABSTRACT

Provided is a fertiliser ring (10), and an associated method for producing such a fertiliser ring (10), the ring (10) broadly comprising a ratio range of i) 60% to 70% manure, ii) 10% to 20% paper waste, iii) 10% to 20% water, and iv) 0.3% to 0.8% NPK compound, wherein the ring (10) is pressed and dried and operatively placeable about a plant (6) to provide controlled-release of nutrients. The fertiliser ring (10) typically also comprises at least one line of weakness (12) along which the ring (10) is breakable or separatable in order to facilitate placement about a stem (8) of the plant (6).

### TECHNICAL FIELD

This invention relates to a method for producing a fertiliser ring, an associated fertiliser ring and a method for fertilising a plant using such a fertiliser ring.

### BACKGROUND ART

The following discussion of the background art is intended to facilitate an understanding of the present invention only. The discussion is not an acknowledgement or admission that any of the material referred to is or was part of the common general knowledge as at the priority date of the application.

Management of soil fertility has been the preoccupation of farmers for thousands of years. Fertilisers enhance the growth of plants. This fertilisation outcome is generally met in two ways, the traditional one being additives that provide plant nutrients, and the second being to enhance the effectiveness of the soil by, for example, modifying soil water retention and aeration.

As is generally known in the art, the three main plant macronutrients are nitrogen (N—beneficial for leaf growth), phosphorus (P—beneficial for development of roots, flowers, seeds, and fruit), and potassium (K—beneficial for stem growth, movement of water in plants, promotion of flowering and fruiting), along with secondary macronutrients (calcium, magnesium, sulphur) along with various micronutrients and trace elements. As such, it is known that the growth of plants can be improved with fertilisation, that is by providing the plant with a ready source of the nutrients that it requires for growth. This is especially necessary in areas with poor-quality soil which is unable to satisfactorily sustain the growth of a large number of plants.

Conventional fertilisers often include various compounds containing nitrogen and phosphorus and other minerals required for plant growth, in forms which can be either sprayed on the soil surrounding the plant or in a solid form such as pellets or granules which can be directly added to the soil. It is also common for conventional fertilisers to contain a PH stabilising component, that is either an acid or base which can alter the soil pH, to acidify basic soil or to make acidic soil more alkaline, as required.

While liquid or granular fertilisers are widely used, slow- and controlled-release fertilisers comprise only around 0.15% of the overall fertiliser market. Besides being more efficient in the utilisation of the applied nutrients, slow-release fertilisers also reduce the impact on the environment and the contamination of the subsurface water.

The low uptake of such slow-release fertilisers stems from perceived shortcomings in their use. In addition to providing the nutrition a plant requires, excess fertiliser can be poisonous to the same plant. It is thus necessary to balance the availability for uptake of fertiliser by plants with the degradation or loss of such slow-release fertiliser. Microbes degrade many fertilisers, e.g. by immobilisation or oxidation. Furthermore, fertilisers are lost by evaporation or leaching.

Slow-release fertilisers (conventional forms including fertiliser spikes, tabs, etc.) further reduce the problem of “burning” the plants due to excess nitrogen. Conventional controlled or slow-release fertilisers are generally traditional fertilisers encapsulated in a shell that degrades at a specified rate. Sulphur is a typical encapsulation material. Other coated products use thermoplastics (and sometimes ethylene-vinyl acetate and surfactants etc.) to produce diffusion-controlled release of urea or other nutrients.

A common type of fertiliser which has been used in the past is animal manure which contains a large number of nutrients excreted by various animals, which when added to soil will improve its capacity to sustain plant growth. While there are significant advantages with the use of manure, in that it is cheap, easy to obtain and a useful means of using a waste product, its use as a fertiliser is also associated with a number of shortcomings.

Firstly, animal manure contains a large number of bacteria which contribute to the unpleasant odour associated with manure, and can also be dangerous when manure fertilisers are used in relation to food crops. Also, the bacteria associated with manure fertilisers contribute to decomposition of the manure and other organic matter associated with it, such that insects are often attracted, forming a pest to the plant itself.

The present invention seeks to provide an improved means for fertiliser application which can overcome the problems associated with applying specific quantities of manure fertilisers, directly suited to the plant and its stage of growth or its genus, while also being relatively inexpensive to produce. It is a further object of the present invention to develop a slow-release fertiliser means which can enrich soils used for plant growth and thereby enhance the growth of the plants, at the same time using waste manure which is high in nutrient value, but overcoming the problems of odour, decomposition and bacterial presence.

### SUMMARY OF THE INVENTION

As is known in the art of geometry, a toroid generally comprises a surface generated by the revolution of any closed plane curve or contour about an axis lying in its plane, including the solid enclosed by such a surface. Similarly, it is to be appreciated that a toroid need not be circular and may have any number of holes. Accordingly, reference herein to a ‘ring’ is to be understood as broadly referring to such a toroid, including a toroidal polyhedron.

In addition, reference herein to an ‘NPK compound’ is to be understood as broadly referring to any suitable compound or admixture including the three main plant macronutrients of nitrogen (N), phosphorus (P) and potassium (K) and optionally secondary macronutrients (such as calcium, magnesium, and sulphur) as well as micronutrients and trace elements.

According to a first aspect of the invention there is provided a method for producing a fertiliser ring, said method comprising the steps of:
combining manure, paper waste, water and an NPK compound in a ratio range of:
   i) 60% to 70% manure;
   ii) 10% to 20% paper waste;
   iii) 10% to 20% water; and
   iv) 0.3% to 0.8% NPK compound;
pressing the resulting mixture of manure, paper waste, water and NPK compound into a ring mold with a force in a range of 30 kN to 70 kN to remove water from said mixture and form said mixture into a ring; and
drying the ring.

In a preferred embodiment, the ratio range of manure, paper waste, water and NPK compound is 66,31% manure, 16,57% paper waste, 16,58% water and 0.54% NPK compound. Of course, variations on the exact proportions of the constituent components are possible, expected and anticipated.

Typically, the method includes a step of mixing the combination of manure, paper waste, water and an NPK compound to reach a predetermined consistency.

Typically, the method includes a step of adding a colouring agent when combining the manure, paper waste, water and NPK compound.

In an embodiment, the colouring agent is selected from a non-exhaustive group consisting of green, brown, yellow, red, orange, blue, white and black.

In an embodiment, the colouring agent is indicative of the ratio range of the manure, paper waste, water and NPK compound, i.e. a specific colour intended for a specific type or species of plant.

Typically, the method includes a step of adding an insecticide and/or pesticide when combining the manure, paper waste, water and NPK compound.

Typically, the method includes the step of microwaving the molded ring for between 1 to 8 minutes for sanitising purposes.

Typically, the method includes the step of capturing the water removed during the step of pressing in order to re-use such water.

Typically, the method includes the step of regulating a pH of the mixture by adding an acid, such as boric or citric acid, or an alkaline, such as caustic soda, as required.

Typically, a pH range of the mixture is regulated to a PH of between approximately 6,8 to 7,4.

Typically, the manure is selected from a non-exhaustive group consisting of horse manure, cow manure, sheep manure, poultry manure and bat manure.

Typically, the paper waste is selected from a non-exhaustive group consisting of paper, cardboard, newsprint and wrapping paper.

Typically, the NPK compound comprises any compound, substance, material or mixture including nitrogen (including slow-release nitrogen in the form of urea and fast release in the form of ammonia), potassium (both soluble and insoluble) and phosphorus (as percentages of sulphur and calcium). Variations on the ratios of the above are possible, expected and within the scope of the invention.

Typically, the step of drying the ring comprises air-drying said ring for a period of 12 to 96 hours.

Typically, an outside diameter of the ring is in a range of 50 mm to 1500 mm to suit plants of different sizes.

According to a second aspect of the invention there is provided a fertiliser ring comprising:
i) 60% to 70% manure;
ii) 10% to 20% paper waste;
iii) 10% to 20% water; and
iv) 0.3% to 0.8% NPK compound;
   wherein the ring is pressed and dried and operatively placeable about a plant to provide controlled-release of nutrients.

Typically, the fertiliser ring comprises at least one line of weakness along which the ring is breakable in order to facilitate placement about a plant.

Typically, the fertiliser ring comprises at least two lines of weakness aligned on opposed sides of the ring to facilitate separation into halves.

In a preferred embodiment, the ring is comprised of a ratio of 66,31% manure, 16,57% paper waste, 16,58% water and 0.54% NPK compound. Of course, variations on the exact proportions of the constituent components are possible and anticipated.

In an embodiment, the ring includes an additional insecticide and/or pesticide.

In an embodiment, the ring includes a colouring agent.

In an embodiment, the colouring agent is selected from a non-exhaustive group consisting of green, brown, yellow, red, orange, blue, white and black.

In an embodiment, the colouring agent is indicative of the ratio range of the manure, paper waste, water and NPK compound, i.e. a specific colour to show an intended use with a specific type or species of plant.

Typically, an outside diameter of the ring is in a range of 50 mm to 1500 mm to suit plants of different sizes.

According to a third aspect of the invention there is provided a method for fertilising a plant, said method comprising the step of placing a fertiliser ring, in accordance with the second aspect of the invention, about a portion of said plant to provide controlled-release of nutrients.

Typically, the fertiliser ring is placed about a stem of the plant.

In an embodiment, the method includes the step of separating the ring into parts via suitable lines of weakness defined therein to facilitate placement about said plant.

According to a further aspect of the invention there is provided a fertiliser ring and an associated method for producing a fertiliser ring, substantially as herein described and/or illustrated.

According to a yet further aspect of the invention there is provided a plant having a fertiliser ring substantially as herein described and/or illustrated fitted about a portion thereof.

### BRIEF DESCRIPTION OF THE DRAWINGS

The description will be made with reference to the accompanying drawings in which:

FIG. 1 is a diagrammatic perspective-view representation of one embodiment of a fertiliser ring, in accordance with an aspect of the present invention;

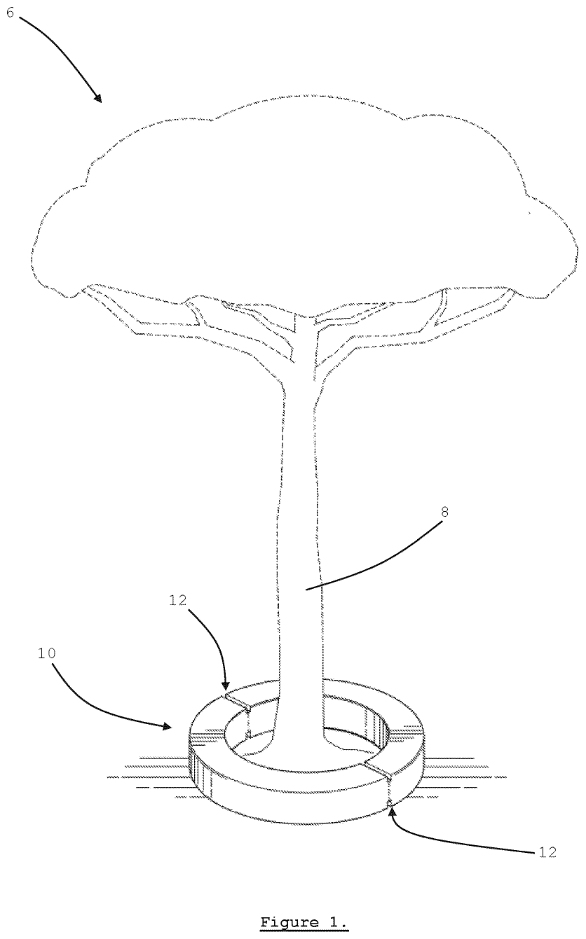

FIG. 2 is a diagrammatic side-view sectional representation of the fertiliser ring of FIG. 1 placed about a plant; and

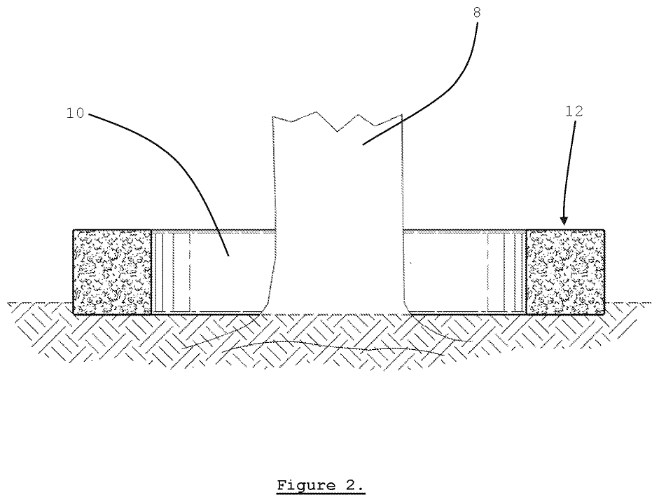

FIG. 3 shows diagrammatic perspective-view representations of examples of different toroid shapes of the fertiliser ring in accordance with an aspect of the present invention.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above. In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

With reference now to the accompanying drawings, the present invention broadly provides for a method for producing a fertiliser ring 10 which can be used to fertilise a plant 6. Advantageously, the ring 10 is operatively placeable about a stem 8 of the plant 6 to provide controlled-release of nutrients in an even and uniform manner, i.e. fertiliser can be evenly applied about the entire plant over a period of time.

The method for producing the ring 10 generally comprises the steps of combining manure, paper waste, water and an NPK compound in a ratio range of:
i) 60% to 70% manure;
ii) 10% to 20% paper waste;
iii) 10% to 20% water; and
iv) 0.3% to 0.8% NPK compound; after which the resulting mixture is pressed into a ring mold with a force in a range of 30 kN to 70 kN (variations hereon are possible and expected) to remove excess water from said mixture and to form said mixture into a ring, after which the ring 10 is dried so that it solidifies or hardens to facilitate easy handling thereof.

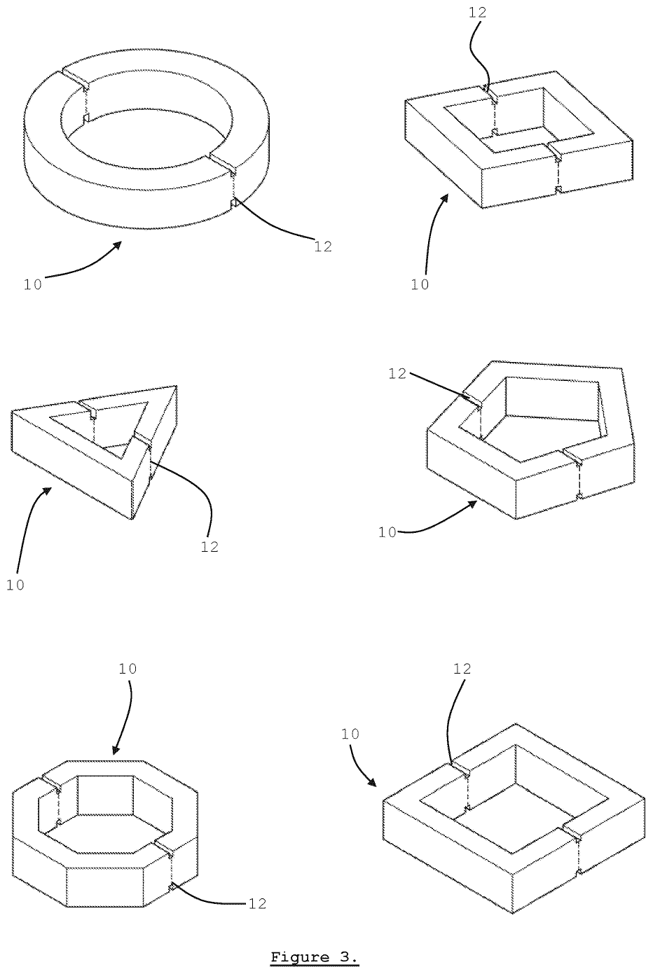

As described above, it is to be appreciated that a ‘ring’ may include any toroid (circular or otherwise, with any number of holes), including a toroidal polyhedron or the like. In essence, the ring 10 can be any shape able to at least partially surround the stem 8 of a plant 6, with some non-limiting examples shown in FIG. 3, e.g. a circle, a triangle, a rectangle, a square, a polygon/polyhedron, etc. In addition, the ring 10 may come in a number of different sizes to suit plants of various sizes, i.e. potted plants, shrubs, trees, etc. Of course, the ratio ranges are selected to total 100%.

In a preferred embodiment, the ratio range of manure, paper waste, water and NPK compound is around 66,31% manure, 16,57% paper waste, 16,58% water and 0.54% NPK compound. Of course, variations on the exact proportions of the constituent components are possible and anticipated. For example, to make roughly 18 rings of 250 mm size, 40 L of manure, 10 L of paper waste, 10 L water, and 26 gm of a suitable NPK compound can be mixed, pressed into ring moulds with a press, such as a hydraulic press, with a force of around 49 kN. During such pressing, the excess water is typically recovered so that it can be recycled into a next batch. Once pressed, the rings are microwaved for approximately 3-5 minutes each to sanitise them, after which they are air-dried for 24-72 hours depending on conditions.

Accordingly, the method typically includes a step of mixing the combination of manure, paper waste, water and an NPK compound to reach a predetermined consistency, e.g. a slurry or similar mixture. In one example, the method includes a step of adding a colouring agent, such as food colouring, when combining the manure, paper waste, water and NPK compound. As will be appreciated, colouring agent may include any suitable colour, such as green, brown, yellow, red, orange, blue, white and black, or the like. In an embodiment, the colouring agent is selected to be indicative of the ratio range of the manure, paper waste, water and NPK compound, i.e. a specific colour useable for a specific type or species of plant.

For example, citrus trees may use an orange colour in which the ratio range has been optimised to suit fertilising requirements of citrus plants, or rose bushes may use red or pink coloured rings, or apple trees may use a green colour, or the like. Again, variations hereon are expected and within the scope of the present invention.

The skilled addressee is to appreciate that various types of manure, or even combinations of manure, can be used. Some possible examples include horse manure, cow manure, sheep manure, poultry manure and bat manure. Similarly, various types of paper waster can be used, such as paper, cardboard, newsprint and wrapping paper, or the like.

Examples of the NPK compound may include any compound, substance, material or mixture including nitrogen (including slow-release nitrogen in the form of urea and fast release in the form of ammonia), potassium (both soluble and insoluble) and phosphorus (as percentages of sulphur and calcium). Variations on the ratios of the above are possible, expected and within the scope of the invention.

In one example, the method may include a step of adding an insecticide and/or pesticide when combining the manure, paper waste, water and NPK compound. The method may also include the step of regulating a pH of the mixture prior to pressing by adding an acid, such as boric or citric acid, or an alkaline, such as caustic soda, as required. Typically, a pH range of the mixture is regulated to a PH of between approximately 6,8 to 7,4. Of course, certain plants and/or soil types may require different pH levels and such variations are expected. As described above, a type of insecticide may be indicated by use of a specific colouring agent, or the like.

The method generally includes the step of microwaving the molded ring for between 1 to 8 minutes for sanitising purposes, and the step of drying the ring generally comprises air-drying said ring for a period of between 12 to 96 hours. Of course, variations hereon as possible and included within the scope of the invention.

As will be appreciated, the invention includes a fertiliser ring produced via such a method, i.e. a ring 10 comprising:
i) 60% to 70% manure;
ii) 10% to 20% paper waste;
iii) 10% to 20% water; and
iv) 0.3% to 0.8% NPK compound; wherein the ring is pressed and dried and operatively placeable about a plant 6 to provide controlled-release of nutrients.

Importantly, the fertiliser ring 10 generally comprises at least one line of weakness 12 along which the ring 10 is breakable or separatable in order to facilitate placement about a stem 8 of the plant 6. Typically, the fertiliser ring 10 comprises at least two lines of weakness 12 aligned on opposed sides of the ring 10, as shown in FIG. 3, to facilitate separation into halves, or the like.

The present invention further includes an associated method for fertilising a plant, said method comprising the step of placing a fertiliser ring 10, as described above, about a portion of said plant 6 to provide controlled-release of nutrients.

Typically, the fertiliser ring 10 is placed about a stem 8 of the plant 6, and the method includes the step of separating the ring into parts via the suitable lines of weakness 12 defined therein to facilitate placement about said plant 6.

A typical analysis of one embodiment of a fertiliser ring 10 produced as described herein is shown in the following table:

| Organic Waste | 77.60% | |
|---|---|---|
| Recycled Waste | 22.40% | |
| (of which) | | |
| Total Nitrogen (N) | 17.4% | w/w |
| Urea (slow release) | 7.3% | w/w |
| Ammonia (quick release) | 4.7% | w/w |
| Total Phosphorus (P) | 1.2% | w/w |
| Water Soluble | 0.2% | w/w |
| Insoluble | 1.0% | w/w |
| Citrate soluble | 0.02% | w/w |
| Total Potassium (K) | 8.6% | w/w |
| Sulphur | 9.3% | w/w |
| Calcium | 2.1% | w/w |
| Trace Elements | | |
| Iron | 4030 | ppm |
| Silicon | 6.80% | |
| Magnesium | 16.00% | |
| Zinc | 93.6 | ppm |
| Manganese | 329 | ppm |
| Copper | 43 | ppm |
| Boron | 21 | ppm |
| Nickel | 30 | ppm |
| Molybdenum | 5.92 | ppm |

| | |
|---|---|
| Calcium Sulphate | 2.53% |

Variations on the above ratios are possible, expected and within the scope of the invention.

Applicant believes it particularly advantageous that the present invention provides for improvements in the use of dispensing fertilisers, and specifically to an improved process to distribute fertilisers using a pressed ring containing an organic waste such as manure and recycled paper, a process for its production and methods of using it to improve the growth of plant by adding specific trace elements and other materials and/or overcome or at least reduce the deleterious effect of insects upon plants. The fertiliser rings may be of various geometric shapes, sizes and designs. Specific colours may also be used to indicate a particular species of plant for which a ring has been formulated.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

Any method steps, processes, and operations described herein are not to be construed as necessarily requiring their performance in the particular order discussed or illustrated, unless specifically identified as an order of performance. It is also to be understood that additional or alternative steps may be employed.

1. A method for producing a fertiliser ring, said method
comprising the steps of:
combining manure, paper waste, water and an NPK compound in a ratio range of:
i) 60% to 70% manure;
ii) 10% to 20% paper waste;
iii) 10% to 20% water; and
iv) 0.3% to 0.8% NPK compound;
pressing the resulting mixture of manure, paper waste, water and NPK compound into a ring mold with a force in a range of 30 kN to 70 kN to remove water from said mixture and form said mixture into a ring, said ring mold configured to define at least one line of weakness along which the ring is breakable in order to facilitate placement about a plant; and
drying the ring.

2. The method of claim 1, wherein the ratio range of manure, paper waste, water and NPK compound is 66,31% manure, 16,57% paper waste, 16,58% water and 0.54% NPK compound.

3. The method of claim 1, which includes a step of mixing the combination of manure, paper waste, water and an NPK compound to reach a predetermined consistency.

4. The method of claim 1, which includes a step of adding a colouring agent when combining the manure, paper waste, water and NPK compound.

5. The method of claim 4, wherein the colouring agent is selected from a non-exhaustive group consisting of green, brown, yellow, red, orange, blue, white and black, and wherein the colouring agent is indicative of the ratio range of the manure, paper waste, water and NPK compound.

6. (canceled)

7. The method of claim 1, which includes a step of adding an insecticide and/or pesticide when combining the manure, paper waste, water and NPK compound.

8. The method of claim 1, which includes the step of microwaving the molded ring for between 1 to 8 minutes for sanitising purposes.

9. (canceled)

10. The method of claim 1, which includes the step of regulating a pH of the mixture by adding an acid, such as boric or citric acid, or an alkaline, such as caustic soda, as required to regulate a pH range of the mixture between 6.8 to 7.4.

11. (canceled)

12. The method of claim 1, wherein the manure is selected from a non-exhaustive group consisting of horse manure, cow manure, sheep manure, poultry manure and bat manure.

13-14. (canceled)

15. The method of claim 1, wherein the step of drying the ring comprises air-drying said ring for a period of 12 to 96 hours.

16. The method of claim 1, wherein an outside diameter of the ring is in a range of 50 mm to 1500 mm to suit plants of different sizes.

17. A fertiliser ring comprising:
i) 60% to 70% manure;
ii) 10% to 20% paper waste;
iii) 10% to 20% water; and
iv) 0.3% to 0.8% NPK compound;
wherein the ring is pressed and dried and operatively placeable about a plant to provide controlled-release of nutrients, said ring comprising at least one line of weakness along which the ring is breakable in order to facilitate placement about a plant.

18. The fertiliser ring of claim 17, which comprises at least two lines of weakness aligned on opposed sides of the ring to facilitate separation into halves.

19. The fertiliser ring of claim 17, which is comprised of a ratio of 66.31% manure, 16.57% paper waste, 16.58% water and 0.54% NPK compound.

20. The fertiliser ring of claim 17, which includes an additional insecticide and/or pesticide.

21. The fertiliser ring of claim 17, which includes a colouring agent selected from a non-exhaustive group consisting of green, brown, yellow, red, orange, blue, white and black, wherein the colouring agent is selected to be indicative of the ratio range of the manure, paper waste, water and NPK compound.

22. (canceled)

23. The fertiliser ring of claim 17, which has an outside diameter in a range of 50 mm to 1500 mm to suit plants of different sizes.

24. A method for fertilising a plant, said method comprising the step of placing a fertiliser ring in accordance with claim 17, about a stem of said plant to provide controlled-release of nutrients.

25. (canceled)

26. The method of claim 24, which includes the step of separating the ring into parts via suitable lines of weakness defined therein to facilitate placement about said plant.

27. (canceled)
